(19) United States
(12) Patent Application Publication
(10) Pub. No.: US 2007/0224463 A1
(43) Pub. Date: Sep. 27, 2007

(54) Fuel Gas Substitution Device for Fuel Cell Stack

(75) Inventor: Koji Morita, Kanagawa (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 10/593,775

(22) PCT Filed: Feb. 23, 2005
(86) PCT No.: PCT/JP05/03421

§ 371 Date: Sep. 22, 2006

(30) Foreign Application Priority Data
Mar. 25, 2004 (JP) 2004-089857

(51) Int. Cl. H01M 8/04

(52) U.S. Cl. 429/12

(57) ABSTRACT

There is provided a fuel gas supply manifold (4) which extends through a plurality of cells (1) in the stacking direction and which is adapted to introduce a fuel gas to the cells (1). There are provided a bypass passage (9) connecting the downstream end of the fuel gas supply manifold (4) to the fuel gas exhaust manifold (7), and a valve (11) for opening and closing the bypass passage (9). When starting the supply of a fuel gas to the fuel gas supply manifold (4), the valve (11) is opened, whereby most of the air in the fuel gas supply manifold (4) is driven away to the exterior through scavenging by the fuel gas by way of the bypass passage (9) without causing it to pass through the interior of the cells.

### TECHNICAL FIELD

The present invention relates to a fuel gas substitution device for a fuel cell stack, and more specifically to a technique for scavenging the interior of a fuel gas supply manifold.

### BACKGROUND ART

JP 09-27334 A discloses a solid polymer electrolyte film type fuel cell. In this fuel cell, a fuel cell stack is formed by stacking together a plurality of unit cells, each of which is composed of an electrolyte consisting of a polymer ion exchange film, and a catalyst electrode and a porous carbon electrode respectively arranged on either side of the electrolyte.

### DISCLOSURE OF THE INVENTION

In a fuel cell stack, a fuel gas supply manifold for distributing and supplying fuel gas to the cells is formed so as to extend in the stacking direction. When, at the start of power generation, the fuel gas starts to be supplied to the fuel gas supply manifold, the atmospheric air which has occupied the fuel gas supply manifold is scavenged by the fuel gas. In this case, the fuel gas advances toward the downstream side within the fuel gas supply manifold while being distributed and supplied to the cells. Thus, immediately after the start of the supply of the fuel gas, a state is generated in which the fuel gas has been introduced into the cells on the upstream side of the fuel gas supply manifold, while no fuel gas has been introduced to the cells on the downstream side thereof. While normal fuel cell power generation is effected in the cells on the upstream side, the start of power generation is delayed on the downstream side, and in this while, discharge occurs due to carbon corrosion attributable to deficiency of fuel gas.

It is an object of the present invention to shorten the requisite time for performing scavenging on the atmospheric air in the fuel gas supply manifold after the start of power generation, and to restrain discharge due to carbon corrosion, which is apt to occur in part of the cells.

In order to achieve above the objects the invention provides a fuel cell stack formed by stacking together a plurality of cells, which comprises a fuel gas supply manifold provided so as to extend through the cells in the stacking direction and adapted to introduce a fuel gas to the cells, a fuel gas exhaust manifold provided so as to extend through the cells in the stacking direction and adapted to collect surplus fuel discharged from the cells, a bypass passage connecting a downstream end of the fuel gas supply manifold to the fuel gas exhaust manifold, and a valve that opens and closes the bypass passage, wherein, when the fuel gas starts to be supplied to the fuel gas supply manifold, the valve is opened to thereby effect scavenging on most of the air in the fuel gas supply manifold through the bypass passage by the fuel gas supplied without causing the air to flow by way of the cells.

### BRIEF DESCRIPTION OF THE DRAWINGS

FIG. 1 is an exploded perspective view of a fuel cell stack according to a first embodiment of the present invention.

FIG. 2 is a diagram showing the voltage rise characteristics of each cell at the time of scavenging.

FIG. 3 is an exploded perspective view of a fuel cell stack according to a second embodiment of the present invention.

FIG. 4 is an exploded perspective view of a fuel cell stack according to a third embodiment of the present invention.

### BEST MODE FOR CARRYING OUT THE INVENTION

In the following, embodiments of the present invention will be described with reference to the drawings.

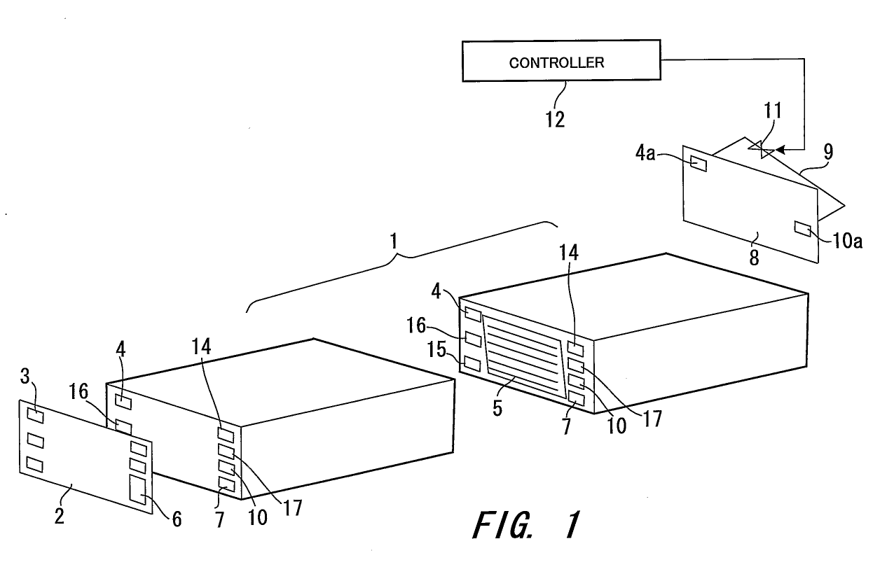

FIG. 1 is a diagram showing a fuel cell stack as separated at a position near the center with respect to the stacking direction. In FIG. 1, the fuel cell stack is formed by stacking together a plurality of unit cells 1 each including an electrolyte and a pair of catalyst electrodes provided so as to sandwich the electrolyte.

Here, power generation in each cell 1 will be schematically illustrated. The anode side catalyst electrode (the fuel electrode) receives a supply of hydrogen as a fuel gas, and the hydrogen is ionized on the catalyst electrodes to become hydrogen ions and electrons.

The hydrogen ions move to the cathode side catalyst electrode (the air electrode), and the electrons flow through an external circuit to move to the cathode side catalyst electrode (the air electrode). Air is supplied to the cathode side catalyst electrode (the air electrode), and oxygen in the air, the hydrogen ions having moved through the electrolyte, and the electrons having moved through the external circuit react with one another to produce water. As a result of the above movement of the electrons through the external circuit, an electric current flows in a direction opposite to the moving direction of the electrons, thus making it possible to obtain electric energy.

In the above fuel cell stack, a first end plate 2 and a second end plate 8 are respectively arranged at both ends thereof. Formed in the fuel cell stack is a fuel gas supply manifold 4 extending through the cells 1 in the stacking direction. The fuel gas supply manifold 4 is situated at an end of the cells 1. Further, at a position on the opposite side of the fuel gas supply manifold 4, there is formed a fuel gas exhaust manifold 7 extending through the cells 1 in the stacking direction.

In each cell 1, there are formed fuel gas channels 5 establishing communication between the fuel gas supply manifold 4 and the fuel gas exhaust manifold 7. The fuel gas channels 5 are arranged in the power generating region of each cell 1. Hydrogen serving as the fuel gas supplied from the fuel gas supply manifold 4 is distributed and supplied to the fuel gas channels 5, and is used for power generation reaction in each cell 1. The portion of the hydrogen not used for the power generation reaction is discharged into the fuel gas exhaust manifold 7.

A fuel gas supply port 3 is open in the first end plate 2, and is connected to the fuel gas supply manifold 4. Further, a fuel gas exhaust port 6 is open in the first end plate 2, and is connected to the fuel gas exhaust manifold 7.

The fuel gas introduced from the fuel gas supply port 3 is distributed from the fuel gas supply manifold 4 to the fuel gas channels 5 of the cells 1, and surplus fuel gas is discharged to the exterior through the fuel gas exhaust manifold 7 and the fuel gas exhaust port 6.

Further provided in the fuel cell stack so as to extend through the cells 1 are a manifold 14 for supplying the requisite air for power generation reaction, an air exhaust manifold 15, a cooling water supply manifold 16 for circulating cooling water for cooling the stack, which is subject to temperature rise due to the power generation reaction, and a cooling water discharge manifold 17.

Incidentally, when starting power generation with the fuel cell, it is necessary to perform scavenging on the atmospheric air (air) that has entered the fuel gas supply manifold during the suspension of power generation. During suspension of power generation by the fuel cell, atmospheric air is allowed to enter the fuel gas supply manifold 4 in the meantime, and the interior of the manifold 4 is filled with atmospheric air with passage of time. No normal power generation state is attained until all the atmospheric air in the fuel gas supply manifold 4 is substituted by the fuel gas. Thus, in order to perform scavenging on the atmospheric air in the fuel gas supply manifold 4, the following construction is adopted.

In the second end plate 8 of the fuel cell stack, a through-port 4a is formed so as to be connected to the downstream end of the fuel gas supply manifold 4.

The fuel cell stack has a bypass exhaust passage 10 extending through the cells 1, independently of the fuel gas exhaust manifold 7 and in parallel to the fuel gas exhaust manifold 7. Formed in the second end plate 8 is a through-port 10a connected to the bypass exhaust passage 10.

Together with the fuel gas exhaust manifold 7, the other end of the bypass exhaust passage 10 is connected to the fuel gas exhaust port 6 provided in the first end plate 2.

Further, there is provided a bypass duct 9 establishing connection between the through-port 4a communicating with the fuel gas supply manifold 4 and the through-port 10a communicating with the bypass exhaust passage 10.

In other words, communication is established between the downstream end of the fuel gas supply manifold 4 and the upstream end of the bypass exhaust passage 10 by the bypass duct 9 arranged outside the fuel cell stack. At some midpoint of the bypass duct 9, there is provided a normally closed type electromagnetic valve 11.

The bypass duct 9 and the bypass exhaust passage 10 constitute the bypass passage of this embodiment.

The minimum passage sectional area of the bypass exhaust passage 10 and the bypass duct 9 is set such that, during normal operation of the fuel cell, in which the electromagnetic valve 11 is closed, it is possible for the fuel gas to flow therethrough in an amount not less than the total amount of the fuel gas flowing through the fuel gas channels 5 of the cells 1. As a result, it is possible to guide the total amount of the fuel gas supplied to the fuel gas supply port 3 directly to the fuel gas exhaust port 6 through a bypass passage without causing it to flow by way of the fuel gas channels 5 of the cells 1.

For this purpose, it should be so arranged that the following formula holds true: D≧d×√N; where D is the diameter of the bypass exhaust passage 10 and the bypass duct 9, d is the diameter of each of the fuel gas channels 5, and N is the total number of fuel gas channels 5 of all the cells 1 (the number of cells multiplied by the number of channels per unit cell).

In order to control the opening and closing of the electromagnetic valve 11, a controller 12 is provided. To start power generation by the fuel cell, the controller 12 causes the electromagnetic valve 11 to be kept open for a predetermined period of time when the fuel gas starts to be supplied to the fuel cell stack.

When the electromagnetic valve 11 is opened, the downstream end of the fuel gas supply manifold 4 is connected to the fuel gas exhaust port 6 by way of the bypass duct 9 and the bypass exhaust passage 10, and it is possible to secure a route for dissipating the atmospheric air in the fuel gas supply manifold 4 to the exterior without allowing it to flow by way of the fuel gas channel 5. The passage sectional area of each of the fuel gas channels 5 provided in the cells 1 is much smaller than the passage sectional area of the bypass duct 9 and the bypass exhaust passage 10, which means they offer great resistance to the gas flow. Thus, when the electromagnetic valve 11 is open, the fuel gas in the fuel gas supply manifold 4 does not flow through the fuel gas channels 5, which offer great flow resistance, and most of the atmospheric air flows through the bypass duct 9 and the bypass exhaust passage 10.

Thus, by keeping the electromagnetic valve 11 open when the fuel gas starts to be supplied, the atmospheric air that has filled the interior of the fuel gas supply manifold 4 during suspension of power generation of the fuel cell is driven away by the fuel gas, thus completing the substituting and scavenging action in a short time.

Thus, the above-mentioned predetermined period of time is previously stored as the necessary and sufficient time for substituting the atmospheric air in the fuel gas supply manifold 4 by the fuel gas, with the electromagnetic valve 11 being open. When the predetermined period of time has elapsed, it is determined that the scavenging of the interior of the fuel gas supply manifold 4 has been completed, and that the fuel gas supply manifold 4 is filled with fuel gas, and the electromagnetic valve 11 is closed by the controller 12.

In this condition, the fuel in the fuel gas supply manifold 4 is discharged into the fuel gas exhaust manifold 7 through the fuel gas channels 5 of the cells 1.

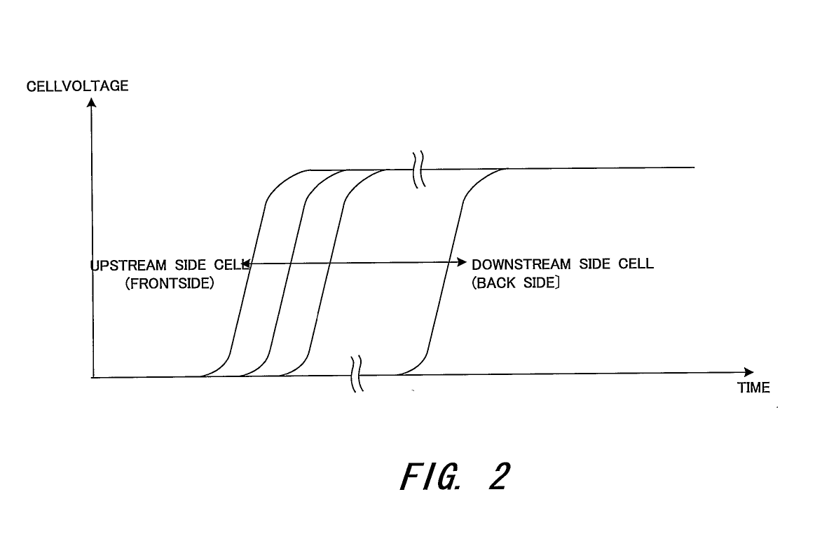

If the bypass duct 9 and the bypass exhaust passage 10 are not provided, when the fuel gas starts to be supplied, the fuel gas supplied to the fuel gas supply manifold 4 will flow through the fuel gas supply manifold 4 while being successively distributed and supplied to the fuel gas channels, starting from the upstream ones, so it takes time to completely perform scavenging on the atmospheric air gathered in the fuel gas supply manifold 4. Thus, as shown in FIG. 2, until the scavenging is completed, normal power generation by the fuel cell is effected (The cell voltage increases) in the upstream side cells 1 through the supply of the fuel gas, while in the downstream side cells 1, due to the delay in the supply of the fuel gas, the power generating action is delayed, and further, there is the possibility of discharge occurring due to carbon corrosion attributable to the deficiency of fuel gas.

In contrast, in the present invention, when starting the supply of the fuel gas, the downstream end of the fuel gas supply manifold 4 is caused to directly communicate with the fuel gas exhaust port 6 through the bypass duct 9 and the bypass exhaust passage 10, so the scavenging is completed in a short time, whereby it is possible to sufficiently diminish the delay of the voltage rise in the downstream side cells with respect to the voltage rise in the upstream side cells, thereby preventing discharge due to carbon corrosion.

Further, after the completion of the scavenging, the electromagnetic valve 11 is closed, whereby it is possible to distribute and supply the fuel gas from the fuel gas supply manifold 4 to the fuel gas channels 5 of the cells 1.

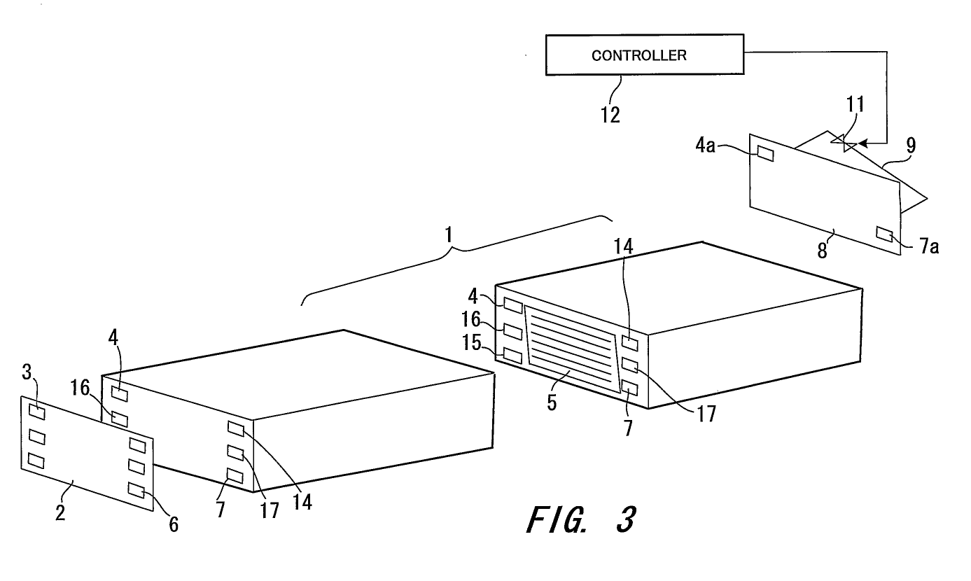

Another embodiment will be described with reference to FIG. 3.

In this embodiment, there is formed in the second end plate 8 a through-port 7a connected to the upstream end of the fuel gas exhaust manifold 7, and one end of the bypass duct 9 is connected to the through-port 7a. As in the above embodiment, the electromagnetic valve 11 is provided at some midpoint in the bypass duct 9.

In this case, the bypass exhaust passage 10 of the first embodiment is not provided. Instead, the fuel gas exhaust manifold 7 is utilized.

Thus, by opening the electromagnetic valve 11 when starting the supply of the fuel gas, the atmospheric air in the fuel gas supply manifold 4 is driven away to the exterior by scavenging by way of the bypass duct 9 and the fuel gas exhaust manifold 7, so its substitution by the fuel gas is completed in a short time.

Instead of providing the bypass duct 9 outside the fuel cell stack, it is also possible to form a bypass passage in the form of a groove on the inner side of the second end plate 8, establishing communication between the fuel gas supply manifold 4 and the fuel gas exhaust manifold 7 (or the fuel gas exhaust passage 10 of FIG. 1) through this bypass passage.

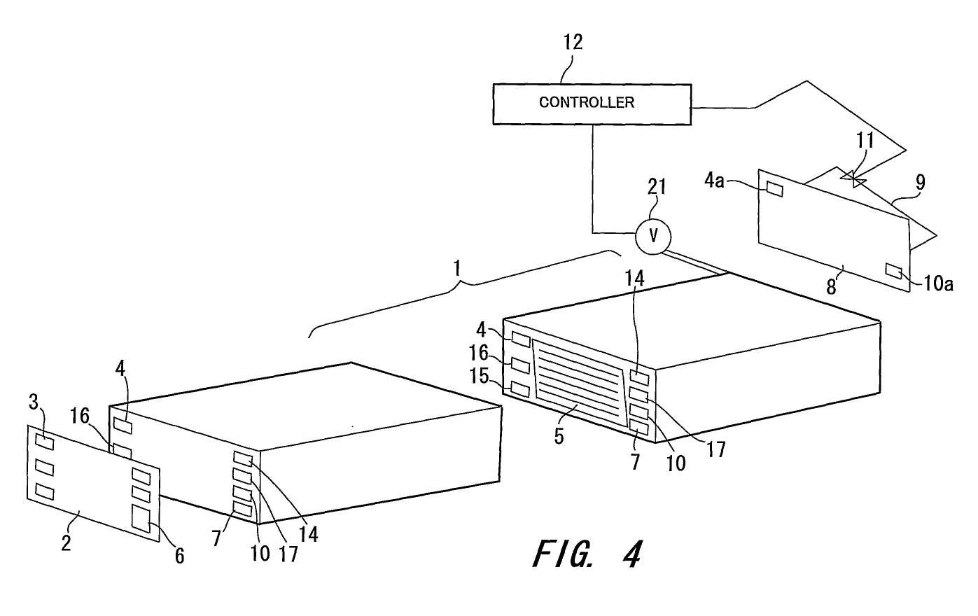

Next, still another embodiment will be described with reference to FIG. 4.

In this embodiment, the timing at which the electromagnetic valve 11 is closed by the controller 12 is made more accurate.

In the construction shown in FIG. 4, the construction of FIG. 1 is additionally provided with a voltage sensor 21 for detecting the voltage in the cells 1 on the downstream side of the fuel gas supply manifold 4, and the timing at which the electromagnetic valve 11 is closed by the controller 12 is controlled based on a detection signal from the voltage sensor 21.

When, at the start of the fuel gas supply, the scavenging on the atmospheric air in the fuel gas supply manifold 4 is completed, and when the interior of the fuel gas supply manifold 4 is filled with fuel gas, the fuel gas is also introduced into the cells 1 on the downstream side of the fuel gas supply manifold 4, with the result that the voltage in the cells on the downstream side rises.

The controller 12 opens the electromagnetic valve 11 simultaneously with the start of the fuel gas supply, and, thereafter, closes the electromagnetic valve 11 when the voltage in the cells 1 on the downstream side of the fuel gas supply manifold 4 exceeds a preset threshold value. In this construction, the electromagnetic valve 11 is closed when the scavenging of the fuel gas supply manifold 4 is completed, and upon detection of the introduction of the fuel gas also to the cells 1 on the downstream side of the fuel gas supply manifold 4. Therefore, even when re-starting is to be effected before much time has elapsed after the stopping of power generation by the fuel cell (i.e., at the time of hot re-start), in other words, even at the time of re-starting in a state in which the gas in the fuel gas supply manifold 4 has not been substituted by atmospheric air yet, or at the time of re-starting while it is being substituted by atmospheric air, it is possible to keep the electromagnetic valve 11 open accurately for the requisite period of time, making it possible to complete the scavenging reliably and in a short time without involving any delay in transition to normal operating state.

In the construction of FIG. 1, when closing the electromagnetic valve 11 after a predetermined period of time has elapsed since the start of the fuel gas supply, it is possible to make a judgment as to whether or not it is hot re-start that is to be effected based on the length of time that has elapsed since the last operation stop, temperature of the fuel cell, etc., thus effecting variable setting of the predetermined period of time according to the result of the judgment. For example, the shorter the period of time left before the re-starting of the fuel cell, the less the amount of atmospheric air broken into in the fuel gas supply manifold 4, so it is possible to shorten the above-mentioned predetermined period of time needed for scavenging.

The present invention is not restricted to the above-described embodiments but allows various improvements and modifications possible for those skilled in the art based on the technical idea as disclosed in the claims.

### INDUSTRIAL APPLICABILITY

The fuel gas substitution device for a fuel cell stack of the present invention is applicable to a vehicle fuel cell, etc.

1. A fuel cell stack formed by stacking together a plurality of cells, comprising:
a fuel gas supply manifold provided so as to extend through the cells in the stacking direction and adapted to introduce a fuel gas to the cells;
a fuel gas exhaust manifold provided so as to extend through the cells in the stacking direction and adapted to collect surplus fuel discharged from the cells;
a bypass passage connecting a downstream end of the fuel gas supply manifold to the fuel gas exhaust manifold; and
a valve 11 that opens and closes the bypass passage,
wherein, when the fuel gas starts to be supplied to the fuel gas supply manifold, the valve is opened to thereby effect scavenging on most of the air in the fuel gas supply manifold through the bypass passage by the fuel gas supplied without causing the air to flow by way of the cells.

2. The fuel cell stack according to claim 1,
wherein the bypass passage is connected to an upstream end of the fuel gas exhaust manifold.

3. The fuel cell stack according to claim 1,
wherein the bypass passage is connected to a downstream end of the fuel gas exhaust manifold.

4. The fuel cell stack according to claim 1,
wherein the bypass passage is formed so as to have a passage area large enough to allow flowing of an amount of fuel gas not less than the total amount of fuel gas flowing through the cells.

5. The fuel cell stack according to claim 1, further comprising a pair of end plates and respectively arranged at both ends of the cells stacked together,
wherein the bypass passage is provided in the end plate situated at the downstream end of the fuel gas supply manifold.

6. The fuel cell stack according to claim 1, further comprising a controller that controls the opening and closing of the valve,
wherein the controller keeps the valve open for a period of time required for performing scavenging on the air in the fuel gas supply manifold.

7. The fuel cell stack according to claim 6, further comprising a voltage sensor that detects the voltage of the cells on the downstream side of the fuel gas supply manifold,
wherein the controller keeps the valve open until the voltage detected by the voltage sensor attains a predetermined voltage since the start of the supply of fuel gas to the fuel gas supply manifold.
